(19) United States
(12) Patent Application Publication
(10) Pub. No.: US 2005/0086526 A1
(43) Pub. Date: Apr. 21, 2005

(54) Computer implemented method providing software virus infection information in real time

(75) Inventor: Mikel Urizarbarrena Aguirre, Bilbao (ES)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Panda Software S.L. (Sociedad Unipersonal)

(21) Appl. No.: 10/688,012

(22) Filed: Oct. 17, 2003

(51) Int. Cl. G06F 11/30

(52) U.S. Cl. 713/201

(57) ABSTRACT

A computer implemented method providing software viruses infection information in real time. It comprises following steps: a) providing a computer virus utility program to a plurality of computer users distributed around different locations, b) obtaining information about geographical location of said computers, c) looking for viruses by searching or scanning said computers; d) sending to a center, through a communication network, a report containing the results of said computer virus search or scanning operation e) processing at said center a plurality of reports received from different local computers and allocate said detected computer viruses in geographical areas, and f) making available information about the most active computer virus at a given time in a series of selectable geographical areas corresponding to said different locations.

### FIELD OF THE INVENTION

The present invention relates generally to the field of data processing systems and data communications for personal computers (PCs) and in particular to a computer implemented method intended to provide in real time and using a communication network, in particular a global one, such as the Internet, computer infection information to multiple users with regard to computer or software viruses extend or spread on a particular geographical area (location and time) and also about the trend of expansion of a virus or viruses helping in this way in alerting said users to better cope with detected viral programs.

The method according to this invention provides information about real risk that users placed at different locations and connected through a communication network face of being infected by a computer virus and the resulting damage it can cause at any given moment, at any of said different locations. In particular and according to a preferred embodiment the method allows any computer user to see the virus infection status in any region, country, and continent or even across the whole world at a first sight or for example just by selecting a geographical area such as a country from a drop-down menu.

Therefore this method while providing a real-time monitoring of computer virus activity in a region and in general across the globe, will aid computer users, through the given information and special warnings provided, to cope at any moment with any computer virus situation and avoiding that they unknowingly and innocently contribute to spread computer viruses.

### BACKGROUND OF THE INVENTION

Since the 1990s, viruses have become a serious problem. Many nasty viruses do irreversible damage, like deleting some or all of the user's files. The Internet is quickly becoming the preferred data communications medium for a broad class of computer users ranging from private individuals to large corporations. Such users now routinely employ the Internet to access information, distribute information, correspond electronically, and even conduct personal conferencing. An ever-growing number of individuals, organizations and business have established a presence on the Internet through “Web pages” on the World-Wide-Web. It has to be remarked that nowadays millions of computers are interconnected through the Internet, which has become a real global network.

As the popularity of the Internet has grown, so too have concerns about breaches in system security, such as computer or software viruses, which may be introduced by data downloaded from the largely-unregulated network. Existing virus scanning utilities typically are installed on end-user systems, but this approach presents in some cases potential problems. Firstly if the virus scan utility is not regularly updated, infected files may still reach a user's system, for example, downloaded from a network or copied from an external storage device without the user's knowledge. The infected data may reside undetected on the user's system for a long period of time, for example, until the next time the user updates his/her antivirus and does a complete system scan, which many users do no more frequently than weekly, if at all. In the meantime, the user may inadvertently pass the infected file to other users. In addition, users may forget to leave virus checking software running, thereby providing infected data with an opportunity to infiltrate their system, and also the virus checking or anti-virus software used may be outdated, that is, lacking the latest known virus pattern files.

It is known to provide anti computer virus programs that apply tests for a large number of known virus types and characteristics. If a computer virus is detected, then a warning is issued to the user and the user is given the option to delete, quarantine or clean the infected file.

US 2002/0103783 discloses a decentralized virus scanning for stored data, such as for example in a networked environment to cope with problems unique to specialized computing devices such as servers, providing protection at the source of the files.

US 2002/0116639 propose a method and apparatus for providing a business service for the detection, notification and elimination of computer viruses for handling a virus in a large network of data processing systems or machines. According to this method in response to detecting a virus infection, a virus scanner and notifier (VSN) residing on a client data processing system sends notification of the presence of a virus to a software module residing at a remote server through a communication link. Said server may then execute an action based on a business policy in response to receiving the notification.

US 2002/0138760 describes a computer virus infection information providing a method for detecting a computer virus in information transmitted between a terminal apparatus and a central apparatus and making available from said central apparatus that stores the communication history of the information transmitted by terminal apparatuses infection information such as the time of infection to the users and thereby permitting the users to understand the time of infection easily.

US 2002/0147915 discloses a method computer program product and network data processing system for the detection, notification and elimination of certain computer viruses on a network using a promiscuous system as bait.

The present invention proposes a new strategy not disclosed in previous proposals, such as the above mentioned prior art, providing to a computer user in real time and in an automatic way information about the existence of active viruses in any particular area where said user operates or intends to operate. The information so made available, in general to any user, is obtained by collecting information about the results of at least a virus detection operation carried out on a big amount of computers spread among several different locations, processing the reports issued and allocating then the detected computer viruses in geographical areas.

The proposed invention also provides information available in general to any computer user, about the expansion or tendency to spread or expand of said viruses, name of them, detailed information on the viruses behavior, and more risky computer viruses i.e. it constitutes a tool acting as a computer viruses forecast, providing at the same time virus cleaning and file repair tools for the computer viruses.

### SUMMARY OF THE INVENTION

This invention refers to a method prepared to offer automatic information of both a threat level of a particular computer virus and the threat level of the combined action of all computer viruses in circulation in a particular geographical area o region acting on PCs (server or work station), i.e. the combined result of the threat levels of each active computer virus in said area which can be described as a computer “virus climate”.

The proposed method provides in fact information allowing knowing the probability of a user of being affected by a computer virus in a specific area, at any given time, due to the extent of viruses or properties of them (particular activity, threat level, etc.).

The importance of knowing the cited computer “virus climate” can be compared to weather reports that help to make decisions before going on a journey. This report should outline the probability of being affected by a computer virus attacks, what type of damage can result (a link to a virus information center capable to provide a help or assistance is also given) and practical information on how to stay safe.

Although computer viruses are a global phenomenon, the inventors have realized that sometimes certain computer viruses hit some regions harder than others. For this reasons the results, i.e., the given information, of the proposed method always correspond to selected geographic regions: states, countries, regions, continents or even the whole world.

Not all the computer viruses pose the same threat to users. Each virus presents a high or low-level threat at any given moment and for this reason according to this invention an index has been created to measure a computer virus threat level. A special feature of the proposed invention is that a value on said index is specific for each computer virus and it is updated in real-time as the virus spreads or the threat recedes: If a virus is spreading rapidly or its capacity to damage systems is high it represents a greater threat and vice versa.

The method of this invention comprises substantially the following steps:
a) providing a computer virus utility program to a plurality of users distributed around different locations each of them operating at least one local computer;
b) obtaining information about geographical location of each of said local computers from said users or by alternating means;
c) carrying out, using said computer virus utility program, at least a computer virus search or scanning operation covering at least a part of at least one hard disk of said local computers or at least a part of a unit supporting information connected or connectable to said local computers;
d) issuing a report containing the results of the search or scanning operation, of any computer virus detected after finishing said at least a computer virus scanning or search operation on at least a part of said local computer and automatically making available the results of said report through a communication network along with at least data of location of said local computer, to a remote center;
e) processing at said center the plurality of reports received from different local computers and allocating said detected computer viruses in geographical areas; and
f) making available information about at least the most active computer viruses at a given time in a series of geographical areas enabled to be selected corresponding to said different locations of step a) and about the percentage of infected computers in each of said geographical areas.

Step f) is periodically updated and the information made available is provided preferably through a local o global communication network such as the Internet.

While to implement the proposed method steps a) to e) need to be carried out, the information made available at step f) can be made accessible to any user (without either execute steps a,b,c) on his/her computer) by simply connecting through a communication network to a particular site offering it.

According to a preferred embodiment said making available the results of said report at step d) to a center is done preserving anonymity of the users having executed step c).

The step c) is performed in general in response to a petition of said user to which the features of the method are presented in general through a communication network and from a site such as a Website (Internet).

Also the making available at step d) is done according to a preferred alternative after prompting a petition to the user of the local computer and obtaining an authorization to send the issued report.

### BRIEF DESCRIPTION OF THE DRAWINGS

FIG. 1 attached to this specification provides a basic diagram of a global implementation of the proposed method.

FIG. 2 shows a schematic representation of the exposed status of virus infection risk.

FIG. 3 shows a map indicating the level of infection in different parts of the world.

FIG. 4 is an alert panel according to one embodiment of this invention showing the level of infection at a global or local level according to a color representation indicative of the level of infection.

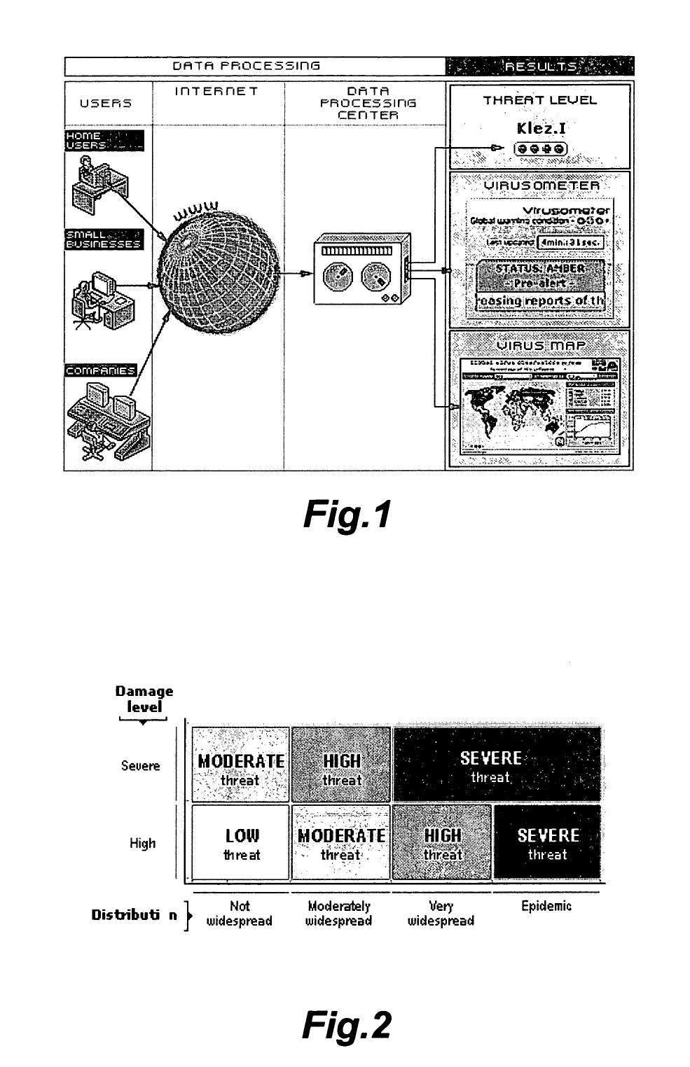

### DETAILED DESCRIPTION

The method of this invention comprises substantially performing steps a) to f) previously detailed. As previously stated and according to a preferred embodiment any user, once the method has been put into operation (i.e. by several users at many different locations having executed steps a) to e)), can have access to the information of step f) by simply reaching a particular site through a communication network such as the Internet.

Said computer virus utility program includes anti-virus software that can reside temporally or permanently in a local computer.

According to a preferred embodiment, the information provided at the step f) is periodically updated information obtained as a result of the plurality of reports processed at step e). In general said information is renewed and issued as soon as new batches of reports from any particular geographical area are processed by said center at step e).

Alternatively said periodically updated information of step f) is renewed each predetermined period of time.

The process of step e) at said center includes statistic operations of the data from the plurality of issued reports received.

In particular, processing operations carried out at step e) will include an evaluation for each of said geographical areas of the number, name and expansion of detected computer viruses.

Therefore the information provided at step f) will also include the extent of some of said most active detected computer virus at any given geographical area.

Additionally this information will preferably include the trend of spread of all of said most active detected computer virus at any given geographical area, during an immediate preceding period of time, the duration of which will be indicated.

In a preferred embodiment step a) of providing said computer virus utility program is carried out on line, downloading a computer virus utility program from a site of a remote provider which also can be a site providing anti-virus tools to the users.

Steps a) and b) can be performed sequentially at any given order. If step b) is the first an indication about the fact that the requested information about geographical location will provide access or allow obtaining a link to a computer anti-virus service will be given.

Step c) can include a heuristic exploration of said local computer in order to detect some files suspected to be infected, the results being also specifically detailed as suspected files in said issued report.

According to a preferred embodiment of the invention if any computer virus is detected in the step c) a virus cleaning and file repair operation could be performed which can comprise:
eliminating the detected computer virus from an infected file or files;
take away the adverse effects caused by a virus on the infected computer; and
remove an infected file or files from said local computer.

Optionally the infected file or files can be quarantined.

Furthermore step c) can selectively be performed:
on the whole or on only a part of the hard disk of said local computer;
on an area interchanging messages of said local computer; or
on an external unit supporting information connected or connectable to said computer;
on one or more files which can be selected.

In a preferred implementation of the invention step d) will include prompting a petition to the user of the local computer in order to obtain an authorization to send the issued report before it being effectively sent through a communication network to said remote center.

The issued report of step d) will include in general the number of times that a detected virus appears in the virus detection operation performed on a local computer at step c).

Said report can also include the number and name of the computer virus/es found. In addition, the number and kind of infected files can also be reported.

In step d) in addition to the geographical location of each local computer, information about the time of the virus scanning operation or performed report is issued. Alternatively said report obtained in step d) can further include the time at which said report is sent to said center.

As an option, also information about the computer operating system of said local computer can be included in said issued report of step d).

The referred plurality of local computers are in general distributed around a wide geographical area including at least two distant regions or States of a country or even all the world if the communication network is a global network such as the Internet.

However the effectiveness of the proposed method will also be apparent when using a particular network such as a large company network covering a plurality of local computers located at different areas (regions or countries). The proposal of this invention clearly differentiates of the disclosed in the cited US 2002/0116639, by providing in this case in addition to performing a cleaning an file repair operation an immediate information about degree of proliferation of a single computer virus or combination of viruses in a particular geographical zone where a user is located, intends to operate or is interested on.

The referred computer virus utility program, the computer user downloads for example from an Internet site to start the method and which could reside only temporally on said local computers, is in addition periodically updated including special anti-virus tools to fight against computer virus newly detected.

Said computer virus utility program can include a communication program through which issued reports of step d) are being sent but in general a communication network such as a global (Internet) o large local one will be used.

According to an implemented version, the method of this invention, depicts the referred computer “virus climate” in the form of color-coded warning conditions in a way similar to that used by emergency services with respect to natural disaster warnings.

According to a preferred embodiment the following warning conditions and indicative colors can be used:

| WARNING | | PREVENTIVE |
|---|---|---|
| CONDITION | DEFINITION | MEASURES |
| Green | Normal status | Apply current preventive |
| (normal) | No indication about any | measures (anti-virus in- |
| | virus or hoax constituting a | stalled, updated and |
| | threat exists | properly functioning). |
| | Low risk of being infected | Be sure that all the compu- |
| | by a computer virus or | ters in use are provided |
| | malicious code, | with a fully updated anti- |
| | | virus. |
| Orange | Pre-alert status | In addition to the precau- |
| (pre-alert | There are indications of the | tions taken under the |
| situation) | potential of some virus be- | “green” warning condition, |
| | coming epidemic. | apply specific preventive |
| | High risk of being infected | measures for the most |
| | by a computer virus or | active computer viruses at |
| | malicious code. | the time. |
| | | In case of an administrator, |
| | | plan an emergency strategy |
| | | against the most virulent |
| | | malicious codes in circula- |
| | | tion or spread viruses. |
| Red | Red alert status | In addition to the previous |
| (alert) | At least one severe threat | precautionary measures |
| | computer virus or (hoax) or | mentioned, apply specific |
| | two high threat computer | security measures against |
| | viruses are in circulation | the severe threat and high |
| | causing an epidemic. | threat computer viruses that |
| | High risk of being infected | are active (content filters, |
| | by a computer virus or | installation of the corre- |
| | malicious code | sponding security patches, |
| | | etc.) |

FIG. 2 shows a schematic representation of the exposed status of virus infection risk, calculated by statistic operations carried out on the data from the plurality of issued reports and processed at step e).

FIG. 4 shows an alert panel indicating the level of infection at a global or local level according to said indicative color representation and including a time reference and alternatively (while not represented) the name of a local area.

It has to be highlighted that each particular situation especially an amber or red warning condition will require specific measures for optimum protection depending of the kind of computer virus or malicious code involved.

The above indications about the status of computer virus infection will in general be accompanied by additional information, clearly explaining the threat level of the computer virus warning condition.

The additional information may include the following:
region o geographical area to which the warning applies: world-wide, continent, country or state/region;
explanation of the severity of the warning condition: for example, when the warning condition is red, one or more computer viruses classified as high threat or severe threat are in circulation and publication of their names, the threat level and the type of systems infected is given;
specific recommendations through message boards directed on how to deal with a specific computer virus or viruses in particular how to remove it or them or how to handle a situation, as well as special alerts.

The information about degree of proliferation of a single computer virus o viruses, or the combination of viruses in a geographical zone can be obtained by selecting said zone from a list. The proportion of infected PC and an indication about the trend of spread of the computer virus or viruses is provided by the method.

According to the invention the cited information about degree of proliferation of a single computer virus or viruses, or the combination of viruses in a geographical zone can additionally or alternatively be obtained in the form of a map that provides the following information:
top viruses: list of the most active computer viruses in a region;
top countries: list of the areas most-affected by a single or all computer virus;
proliferation of infection graph: displays the development of PCs infected by a computer virus or all viruses, in each area from the last 24 hours to the past 12 months.

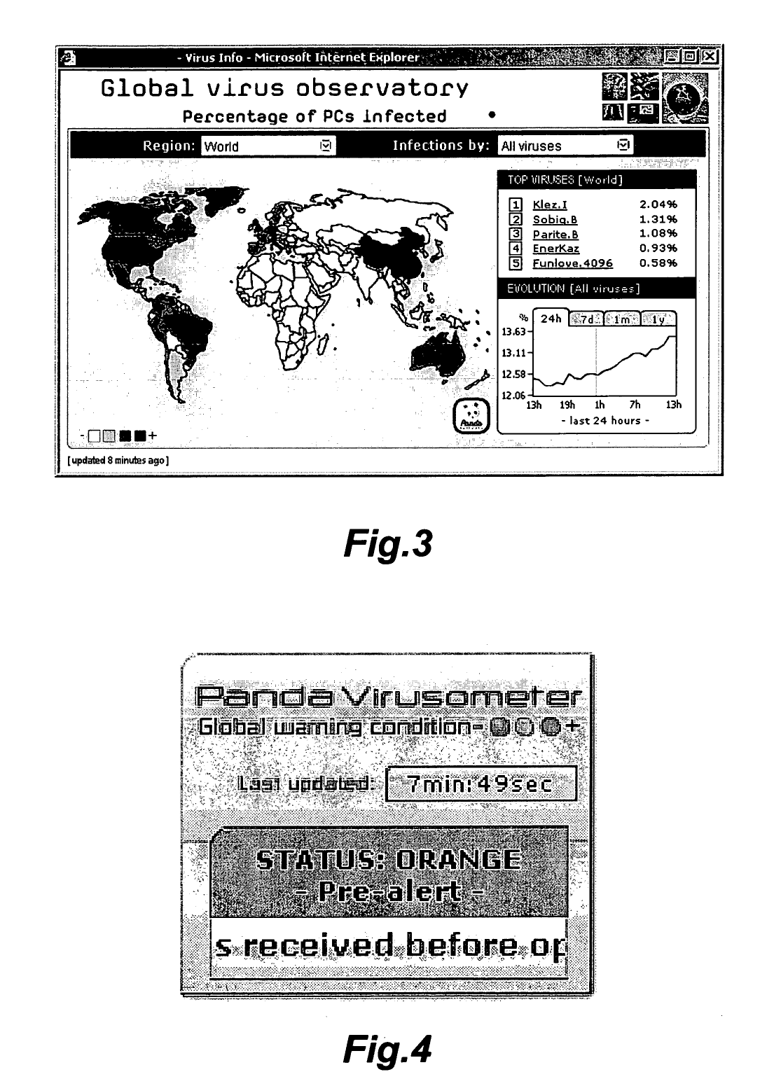

Usually the map (see FIG. 3) will open as a world map, displaying continents and indicating the level of infection using different color codes. If a user click on a continent, the map will display an expanded version, with each country colored according to its current computer virus status, and a single country can also be selected obtaining more detailed information.

In addition the cited map offers two options. The first of these: region, allows selecting the geographic area of interest by simply clicking the desired area. The second option: by infection, allow choosing the name of virus or hoax causing an infection displaying the geographic area infected.

This virus map provides a live graphic coverage of the impact of computer viruses in diverse geographic regions.

On the other side, by the panel represented in FIG. 4 one can obtain at a first sight quick information about the degree of infection at a global or local level, which can be of help to adopt necessary protective measures.

1. A computer implemented method providing software viruses infection information in real time, the method comprising following steps:
a) providing a computer virus utility program to a plurality of users distributed around different locations each of them operating at least one local computer;
b) obtaining information about geographical location of each of said local computers;
c) carrying out, using said computer virus utility program, at least a computer virus search or scanning operation covering at least a part of at least one hard disk of said local computer or at least a part of a unit supporting information connected or connectable to said local computer;
d) issuing a report containing the results of said computer virus search or scanning operation on said local computer and making available the results of said report through a communication network along with at least data of said geographical location of said local computer, to a center;
e) processing at said center a plurality of reports received from different local computers and allocating said detected computer viruses in geographical areas; and
f) making available information about at least the most active computer virus at a given time in a series of selectable geographical areas corresponding to said different locations of step a).

2. A computer implemented method, according to claim 1, wherein said step a) of providing said computer virus utility program is carried out on line or off line.

3. A computer implemented method, according to claim 1, wherein said steps a) and b) are performed sequentially at any given order.

4. A computer implemented method, according to claim 1, wherein said computer virus utility program is an anti-virus software.

5. A computer implemented method, according to claim 4, wherein if any computer virus is detected a virus cleaning and file and system repair operation is performed at least on a scanned part of the computer providing said detection.

6. A computer-implemented method, according to claim 1, wherein said information made available at step f) is periodically updated.

7. A computer implemented method, according to claim 1, wherein said information provided at step f) is made available to any user of a computer through a communication network.

8. A computer implemented method, according to claim 1, wherein said information provided at said step d) further includes the number of times that a detected virus appears in said computer detection operation of step c).

9. A computer implemented method, according to claim 1, wherein said information provided at said step f) further includes the percentage of infected computers at a selected geographical area.

10. A computer implemented method, according to claim 1, wherein said information provided at said step f) further includes a trend of spread of some of said most active detected computer virus at any given geographical area during an immediate preceding period of time.

11. A computer implemented method, according to claim 1, wherein said computer virus search or scanning operation of step c) is performed after a request of permission to said user.

12. A computer implemented method, according to claim 1, wherein said report issued at step d), also includes a definite time when said at least a computer virus search or scanning operation is performed.

13. A computer implemented method, according to claim 1, wherein said making available the result of said report at step d) to a center is done preserving anonymity of said user.

14. A computer implemented method, according to claim 1, wherein said step c) is performed on the whole of said at least one hard disk or on the whole of all hard disks of said local computer that can be selected by said user.

15. A computer implemented method according to claim 1, wherein said step c) is performed on an area interchanging messages of said local computer.

16. A computer implemented method, according to claim 1, wherein said step c) is carried out on one or more files of said local computer.

17. A computer implemented method, as claimed in claim 1, wherein said step c) also includes an heuristic exploration of said local computer in order to detect some files suspected to be infected, the results being also included as suspected files in said issued report.

18. A computer implemented method, as claimed in claim 1 wherein said report issued at step d) further includes the definite time at which said report issued at step d) was sent by said center.

19. A computer implemented method, as claimed in claim 1 wherein said report issued at step d) further includes the definite time at which the virus search or scanning operation ended.

20. A computer implemented method, as claimed in claim 1 wherein said step e) further includes evaluate for each of said geographical areas the number, name and degree of spreading of detected computer viruses or files and number of them suspected to be infected.

21. A computer implemented method, as claimed in claim 1, wherein said plurality of local computers are distributed around a wide geographical area.

22. A computer implemented method, as claimed in claim 21, wherein said plurality of local computers are distributed around the world.

23. A computer implemented method, as claimed in claim 1, wherein said communication network is a global network such as the Internet.

24. A computer implemented method, as claimed in claim 1, wherein said communication network is a particular network such as a large company network.

25. A computer implemented method, as claimed in claim 5, wherein said computer virus search or scanning operation of step c) comprises removing the detected computer virus from an infected file or files so that the file can be used again.

26. A computer implemented method, as claimed in claim 5, wherein said computer virus search or scanning operation of step c) comprises quarantining the infected file or files.

27. A computer implemented method, as claimed in claim 5, wherein said computer search or scanning operation of step c) comprises repair the adverse effects of the computer virus in the infected computer.

28. A computer implemented method, as claimed in claim 5, wherein said computer virus search or scanning operation of step c) comprises remove an infected file or files.

29. A computer implemented method, as claimed in claim 1, wherein said computer virus utility program is periodically updated including special anti-virus tools to fight against reported new active computer virus detected.

30. A computer implemented method, as claimed in claim 1, wherein said computer virus utility program loaded in said local computers includes a communication program.

31. A computer implemented method, as claimed in claim 30, wherein said issued reports are being sent using said communication program.

32. A computer implemented method, as claimed in claim 1, wherein in addition to the geographical location of said local computers, information about the computer operating system of said local computers is included in the issued reports of step d).

33. A computer implemented method, as claimed in claim 1, wherein said issued reports include in addition to the number and name of computer virus found, the number and kind of files infected.

34. A computer implemented method, as claimed in claim 6, wherein said periodically updated information of step f) is renewed and issued as soon as new batches of reports from any particular geographical area are processed by said center at step e).

35. A computer implemented method, as claimed in claim 6, wherein said periodically updated information of step f) is renewed each predetermined period of time.

36. A computer implemented method, as claimed in claim 1, wherein said process of step e) at said center includes statistic operations of the data from the plurality of issued reports received.

37. A computer implemented method, as claimed in claim 1, wherein said information of said step f) is provided from a Website.

38. A computer implemented method, as claimed in claim 37, wherein said Website is a site further providing anti-virus tools for the users.

39. A computer implemented method, as claimed in claim 37, wherein in case a very active computer virus being detected an alarm is generated to the users through said Website.

40. A computer implement method, as claimed in claim 37, wherein a Web browser is used to reach said Website in order to obtain said information or to download a computer virus utility program.

41. A computer implement method, as claimed in claim 37, wherein a special software utility program is used to reach said Website in order to obtain said information.

42. A computer implement method, as claimed in claim 2, wherein said on line provision involves downloading a computer virus utility program from a site of a remote provider.

43. A computer implement method, as claimed in claim 42, wherein said downloaded computer virus utility program resides only temporally in said local computers.

44. A computer implement method, as claimed in claim 42, wherein said downloaded computer virus utility program resides permanently in said local computers.
